(19) United States
(12) Patent Application Publication
(10) Pub. No.: US 2017/0303078 A1
(43) Pub. Date: Oct. 19, 2017

(54) METHODS AND SYSTEMS FOR LOCALIZATION OF MOBILE APPLICATION

(71) Applicant: LinguaNext Technologies Pvt. Ltd., Pune (IN)

(72) Inventor: Rajeevlochan PHADKE, Pune (IN)

(73) Assignee: LinguaNext Technologies Pvt. Ltd., Pune (IN)

(21) Appl. No.: 15/488,390

(22) Filed: Apr. 14, 2017

Related U.S. Application Data
(60) Provisional application No. 62/323,468, filed on Apr. 15, 2016.

(51) Int. Cl. H04W 4/02; G01S 5/02; H04W 64/00; G01S 19/42; H04L 29/08; H04W 4/12

(52) U.S. Cl. CPC H04W 4/02; H04L 67/16; H04W 4/12; H04L 67/18; H04W 64/00; G01S 19/42; G01S 5/0284

(57) ABSTRACT

The invention relates to a method and system for localization of a mobile application executing on a computing device. In one embodiment, locations of one or more functions related to display of an item on a mobile application interface are identified and translation libraries including pointcuts are inserted for the locations, wherein the pointcuts intercept the one or more functions and form a communication channel between the locations and a translation engine. The calls from the mobile application to the one or more functions are then intercepted and text strings from the intercepted calls are transmitted to the translation engine. The translated text string corresponding to the intercepted text string are received from the translation engine and transmitted to the one or more functions for presentation on an interface.

### RELATED APPLICATIONS

The present application makes reference to, claims priority to, and claims benefit of U.S. Provisional application Ser. No. 62/323,468 entitled “METHODS AND SYSTEMS FOR LOCALIZATION OF MOBILE APPLICATIONS” filed on Apr. 15, 2016, the complete subject matter of which is hereby incorporated herein by reference, in its entirety.

### FIELD OF INVENTION

The invention relates generally to mobile applications installed in computing devices, and more particularly to methods and systems for localization of mobile applications.

### BACKGROUND

The localization of mobile applications is a process carried out to adapt mobile applications to a particular country or region including translating content of the mobile applications in a local format such as the text, currency and date. Mobile application development on various operating systems like Android, iOS, etc. requires different development environment and, and hence the development and upgrades for each operating system may require different methodologies. Making such mobile applications and the updates multilingual across multiple operating systems, therefore, becomes a very complex task. Moreover, most mobile applications do not have a built-in support for localization and localization usually begins at a very later stage in an application lifecycle after gathering the response of an application in one region.

There are various existing techniques for making mobile applications multi-lingual to cater to the users of a mobile application in diverse languages. One approach towards enabling localization is to re-do the whole code after the mobile application is built for one language. The re-doing of the application code involves tracking locations in the application code where visual elements having language implications on a user interface may be embedded, extracting the strings from those locations in external files and modifying the application codes to read the strings from these external files before display. This process involves creation of multiple translation files for multiple languages for the strings externalized in the files. As a result, the external file has to be included in the application each time a new language is to be added. However, this process is cost inefficient and prone to errors. Moreover, re-doing of the source code is risky especially when done by a person who is not the developer of the original mobile application for reasons such as lack of documentation at source code level, lack of accuracy in capturing all content requiring translation, etc.

Another approach to enable localization is in-place localization wherein the original text in the original application code is identified and replaced with corresponding translated text. However, in-place localization is overall an inefficient method as the mobile application code is required to be maintained separately for separate languages and any change in the original mobile application code warrants performing similar change separately in the corresponding translated mobile application. Thus, maintenance of multiple mobile applications for multiple languages is cumbersome.

Accordingly, there arises a need for a scalable solution capable of allowing localization of mobile application without requiring extensive changes in the application code or maintaining multiple application codes for multiple languages and thus, improving the efficiency in performing localization of mobile applications.

### SUMMARY OF DISCLOSURE

This section is provided to introduce certain objects and aspects of the disclosed methods and systems in a simplified form that are further described below in the detailed description. This summary is not intended to identify the key features or the scope of the claimed subject matter.

In view of the shortcomings of existing methods and systems, as discussed in the background section, it is apparent that there exists a need for developing an improved solution to facilitate translation for existing mobile applications that not only overcomes the problems of the prior art in generating localized mobile applications but also advantageously used to achieve scalability and cost efficiency. It is, therefore, an object of the disclosed invention to provide a method and system that enable localization of mobile application without requiring extensive changes in the original code of the mobile application.

More particularly, the object of the invention is to facilitate seamless localization of mobile applications in order to improve efficiency and consistency across different platforms and mobile operating systems.

Yet another object of the invention is to provide a reliable method and system to facilitate translation for existing mobile applications through aspect oriented programming without modifying the original logic or code of the mobile applications.

In view of these and other objects, the present invention relates to methods and systems for localization of mobile applications. More particularly, in one embodiment, the invention discloses a method for localization of a mobile application, the method comprising identifying one or more locations of one or more functions related to display of one or more items in the mobile application and inserting one or more translation libraries for the one or more locations. The one or more translation libraries include at least one aspect file, wherein the at least one aspect file includes at least one pointcut configured to intercept the one or more functions and to form at least one communication channel between the one or more locations and a translation engine. The method further comprises building the mobile application to install the at least one pointcut in the mobile application using the at least one aspect file; Furthermore, the method comprises intercepting a request from the mobile application to the one or more functions, wherein the request includes a source text string. The at least one source text string is transmitted to the translation engine via the at least one communication channel. Further, the at least one translated text string corresponding to the at least one source text string is received from the translation engine and gets rendered on an interface on execution of the one or more functions.

Further, the present invention relates to a system for localization of a mobile application, wherein said system comprises one or more hardware processors configured to communicate with a tangible, non-transitory memory. The one or more hardware processors comprises an identification module configured to identify one or more locations of one or more functions related to display of one or more items in the mobile application. The system further comprises a weaving module configured to insert one or more translation libraries for the one or more locations, wherein, the one or more translation libraries include at least one aspect file. The at least one aspect file includes at least one pointcut configured to intercept the one or more functions and to form at least one communication channel between the one or more locations and a translation engine. The weaving module is further configured to build the mobile application to install the at least one pointcut in the mobile application using the at least one aspect file. The system further comprises an interception module configured to receive a request from the mobile application to the one or more functions, wherein the request includes at least one source text string. The interception module is further configured to transmit the at least one source text string to the translation engine. Furthermore, the system comprises a localization module configured to receive the at least one translated text string corresponding to the at least one source text string from the translation engine. The localization module is further configured to render the at least one translated text string on an interface on execution of the one or more functions.

Other objects, features, and advantages of the present invention will become apparent from the following detailed description.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. Also, the embodiments shown in the figures are not to be construed as limiting the invention, but the possible variants of a method and system for localization of mobile applications according to the invention are illustrated herein to highlight the advantages of the invention.

FIG. 1 illustrates an exemplary system for localization of mobile application, in accordance with an embodiment of the present disclosure.

FIG. 2 illustrates an exemplary method for building a translation repository, in accordance with an embodiment of the present disclosure.

FIG. 3 illustrates a flowchart depicting an exemplary method for localization of mobile application, in accordance with an embodiment of the present disclosure.

### DETAILED DESCRIPTION OF EXEMPLARY EMBODIMENTS

The following description of example methods and systems is not intended to limit the scope of the description to the precise form or forms detailed herein. Instead in the following description, for the purposes of explanation, various specific details are set forth in order to provide a thorough understanding of the disclosed embodiments. It will be apparent, however, that the disclosed embodiments may be practiced without these specific details.

Several features described hereafter can each be used independently of one another or with any combination of other features. However, any individual feature may not address any of the problems discussed in the background section or might address only some of the problems discussed therein.

While aspects of described system and method for localization of a mobile application may be implemented in any number of different computing systems, environments, and/or configurations, the embodiments are described in the context of the following exemplary system.

Unless defined otherwise, all technical and scientific terms used herein have the same meanings as commonly understood by one of ordinary skill in the art to which the invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

The present invention relates to method and system for localization of mobile application. “Localization” of a mobile application refers to enabling the mobile application for operability in a local language. “Localization” includes translation of text strings associated with a mobile application from a first language to a second language i.e. the local language.

“Pointcuts” herein refer to a set of join points supported by the Aspect Oriented Framework. Pointcuts define join points in the execution of a program of an application as to where an additional program code associated with the pointcut is to be executed. The pointcut allows specifying when and where the additional program code is to be executed in addition to the already existing program.

In the present disclosure, the localization of the mobile application through Aspect-Oriented programming involves weaving of an aspect in the mobile application code so as to intercept text strings from calls to specific functions in the mobile application code by a translation library. The text strings are then transmitted to the translation engine which receives the translated text strings corresponding to the intercepted text strings and transmits the same to the translation library. The translation library then provides the translated text strings to the specific functions called.

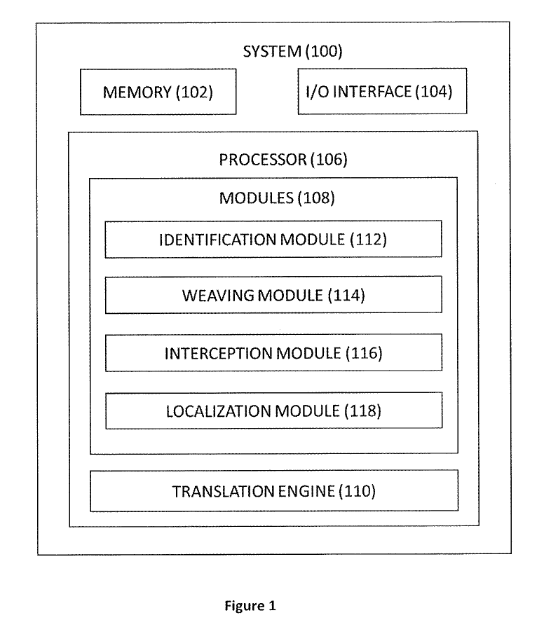

FIG. 1 illustrates an exemplary system (100) in a computing device used for localization of mobile applications, in accordance with an embodiment of the present disclosure. A computing device may be, for example, a mobile electronic device having firmware/software such as mobile cellular phone handsets, phablets, etc. Said computing device has installed therein at least one mobile application that may be localized using the system (100) encompassed by the present disclosure.

In one embodiment, the system (100) includes one or more processors (106), a memory (102) and an Input/Output Interface (104). The one or more processors (106) are hardware processors and may be implemented as one or more microprocessors, microcomputers, microcontrollers, digital signal processors, central processing units, state machines, logic circuitries, and/or any devices that manipulate signals based on operational instructions. Among other capabilities, the one or more processors (106) may be configured to fetch and execute computer-readable instructions stored in the memory (102).

The memory (102) may include any tangible, non-transitory computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The I/O interface (104) may include a variety of software and/or hardware interfaces, for example, a web interface, a graphical user interface, etc. The I/O interface (104) allows the system (100) to interact with a user either directly or through the user devices (not shown in figures). Further, the I/O interface (104) may enable the system (100) to communicate with other computing devices, such as web servers and external data servers (not shown). The I/O interface (104) can facilitate multiple communications within a wide variety of networks and protocol types, including wired networks (e.g. LAN, cable networks, etc.) and wireless networks (e.g., WLAN, cellular networks, or satellite networks). The I/O interface (104) may include one or more ports for connecting a number of devices to one another or to another server.

The system (100) further comprises modules (108) and a translation engine (110) realized in the one or more hardware processors (106). In an embodiment, the modules (108) are included in the memory (102) in communication with the one or more hardware processors (106). The modules (108) include an identification module (112), a weaving module (114), an interception module (116) and a localization module (118). The system (100) is used for providing localized content of a mobile application to a user. To generate the localized mobile application content, the system (100) uses Aspect-Oriented Programming which includes tracking functions in the mobile application source code that are candidates for aspect-oriented programming to be applied, so as to provide a localized mobile application content.

The identification module (112) of the system (100) is configured to identify one or more locations of one more functions in a source code of the mobile application, wherein said one or more functions are related to display of one or more items on a user interface. The one or more functions are related to the display of items including, but not limited to, text, numeric value, images and videos with embedded text. Once such one or more functions are identified, aspect-oriented programming techniques may be applied across the one or more functions to intercept and manage localization of the mobile application.

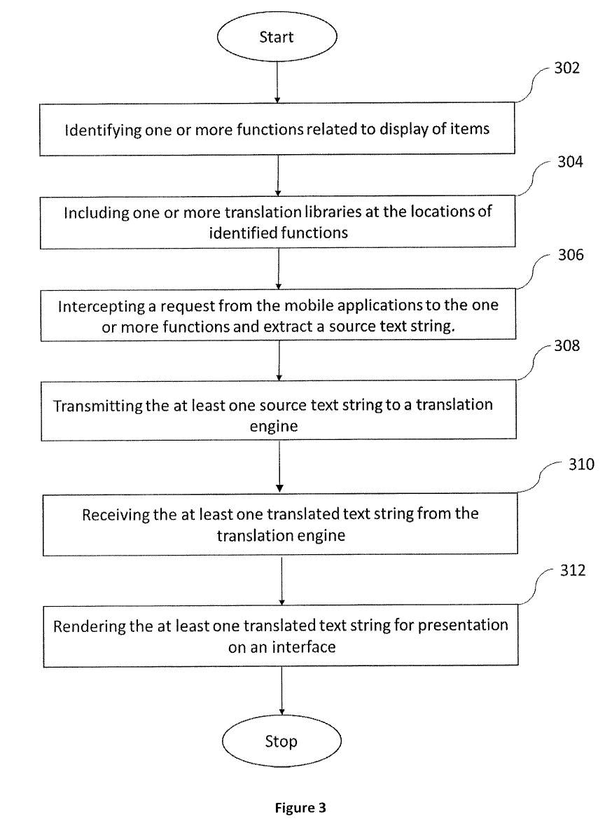

The system further comprises a weaving module (114) configured to insert one or more translation libraries for the one or more locations of the identified one or more functions. The one or more translation libraries include at least one aspect file, wherein the at least one aspect file further includes a pointcut mechanism for each of the one or more functions identified by the identification module (112). These pointcuts intercept one more calls to the one or more identified functions and extract text strings from one or more calls. The extracted text strings include the text associated with the mobile application, which are to be displayed on the user interface associated with the mobile application and may include, but not limited to, a string of alphabets, a numeric value, an image file path and text embedded in an image or a video to be displayed. Further, the inclusion of the pointcut mechanism enables creation of a communication channel between the pointcuts and a translation engine (110). The translation engine (110) is capable of providing translated text strings corresponding to text strings extracted from one or more calls to one or more functions. The translation engine (110) is further in communication with a translation repository of source text strings and corresponding translated text strings. The creation of the translation repository is explained with respect to FIG. 3. The invention further encompasses building the mobile application so as to have the pointcuts installed in the mobile application.

The system (100) further comprises an interception module (116) configured to intercept a call/request to the one or more identified functions using the translation library. The interception module (116) is configured to intercept/extract source text strings from each request/call to the one or more identified functions related to the display of one or more items using the translation library. The pointcut mechanism in the translation library redirect the execution of the one or more functions to the communication channel which facilitates communication between the pointcuts and the translation engine (110). The source text strings extracted from each request/call are then transmitted to the translation engine (110). The source text strings include text associated with the mobile application such as a string of alphabets, a numeric value, an image file path, text embedded in an image to be displayed. In an embodiment, the source text strings may include any text within the mobile application that needs to be translated along with information required for formatting of the text for display on the user interface such as font attributes. The interception module (116) is configured to extract/intercept source strings from each call before the call is transmitted to the execution library of the mobile application for execution of the one or more identified functions.

The system further comprises a localization module (118) configured to provide the translated text string for displaying on the user interface of the mobile application, wherein the localization module (118) receives the translated text strings from the translation engine (110) which looks-up the translated text strings in the translation repository (not shown in the figure). The localization module (118) is configured to transmit the translated text strings to the one or more functions for display on the user interface on execution of the mobile application. In one embodiment, the translated text strings are in a language of the computing device on which the mobile application is installed, wherein the language of the computing device refers to a preferred language selected by a user of the computing device.

The invention further encompasses the localization module (118) configured to store the source text strings in the translation repository in an event the corresponding translated text string is not found in the translation repository. In one embodiment, where a new function related to a visual element is added, the localization module (118) is configured to store the new text string in the translation repository, wherein the new text string related to the new function is translated by the translation engine (110). Further, language localization is achieved for the updated versions of the mobile application without requiring any changes in the mobile application code.

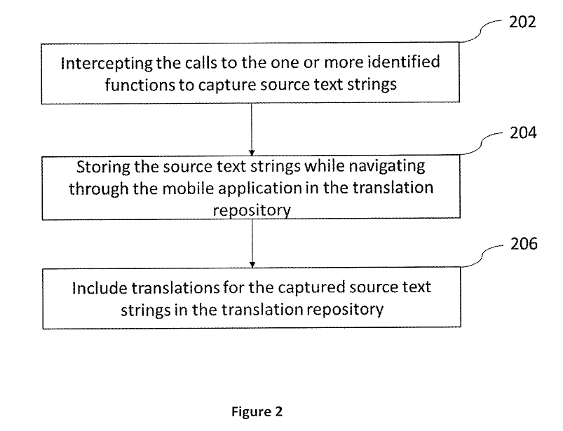

FIG. 2 illustrates an exemplary method to create the translation repository. The invention encompasses building a translation repository by capturing source text strings intercepted from one or more calls to the one or more identified functions, storing the captured text strings and providing corresponding translated text strings. The source text strings are captured continuously as the user navigates through different screens/user interfaces throughout the mobile application covering all possible conditions and text associated with the mobile application so that all the text strings which may be displayed at any user interface associated with the mobile application is captured. In an embodiment, the translation repository is built when the application is executing in an extraction mode. With respect to FIG. 2, at step 202, each time a call is made to the one or more functions related to display of an item on the user interface, the interception module (116) extracts the source text strings from the call, transmits the extracted source strings to the localization module (118). At step 204, the localization module (118) stores the extracted source strings received from the interception module (116) in a file called translation repository. At step 208, the localization module (118) is further configured to include translations for the extracted source strings in the translation repository. The translations may be included by performing at least one of language dictionary look-up and a phonetic transliteration of the source text strings. The translation repository comprises one or more pairs of original source text strings and the corresponding translated text strings. In an embodiment, the localization module (118) may create translations in multiple languages such that application code need not be changed at any time the mobile application requires localization.

FIG. 3 illustrates a flowchart depicting an exemplary method for localization of mobile application, in accordance with an embodiment of the present disclosure. The method of FIG. 3 implements the system of FIG. 1. The method 300 of FIG. 3 begins at step 302, wherein one or more locations where one or more functions related to display of one or more items in the mobile application, are identified.

The one or more items include any visual element having a language implication such as a text, a numeric value, an image/video with embedded text to be displayed on the user interface of the mobile application.

At step 304, one or more translation libraries are included at the locations of the one or more identified functions, wherein, the one or more translation libraries include at least one aspect file. The at least one aspect file further includes a pointcut mechanism for each of the identified functions. The pointcuts intercept source text strings from one or more calls made by the functional part of the mobile application code to the one or more identified functions. The inclusion of the pointcut mechanism enables formation of a communication channel between the pointcuts and a translation engine (110). The translation engine (110) is capable of providing translated text strings corresponding to extracted source text strings. The translation engine (110) is further in communication with a translation repository of source text strings and corresponding translated text strings. The method further comprises building the mobile application so as to have the pointcuts installed in the mobile application.

At step 306, the method comprises intercepting a request/call from the functional part of the mobile application code to the one or more functions wherein the request includes a source text string by the translation library. The source text strings are then extracted from the intercepted call using the pointcuts in the translation library.

At step 308, the method comprises transmitting the source text strings to the translation engine (110) via the at least one communication channel.

At step 310, the method comprises receiving translated text string corresponding to the at least one source text string from the translation engine (110). The translation engine (110) provides the translated text strings by looking-up in a translation repository. In one embodiment, the translated text strings are in a language of the computing device on which the mobile application is installed, wherein the language of the computing device refers to a preferred language selected by a user of the computing device.

At step 312, the translated text strings are transmitted to the one or more identified functions for replacing the source text string with the translated text string. The translated text strings are then rendered for presentation on the user interface on execution of the one or more functions.

It will be appreciated by those skilled in the art that the system and method described herein above helps in localization of mobile applications without requiring any changes in the mobile application source code and thus enabling cost efficient and faster solution for localization of mobile applications. In one embodiment, the system and method encompassed by the present invention may be used in performing localization in mobile applications which do not have any built-in localization or internationalization features.

Although implementations for methods and systems for localization of mobile applications have been described in language specific to structural features and/or methods, it is to be understood that the appended claims are not necessarily limited to the specific features or methods described. Rather, the specific features and methods are disclosed as examples of implementations for localization in mobile applications.

I/We claim:

1. A processor-implemented method for localization of a mobile application, the method comprising:
identifying one or more locations of one or more functions related to display of one or more items in the mobile application;
inserting one or more translation libraries for the one or more locations, wherein, the one or more translation libraries include at least one aspect file, wherein the at least one aspect file includes at least one pointcut configured to intercept at the one or more functions and to form at least one communication channel between the one or more locations and a translation engine;
building the mobile application to install the at least one pointcut in the mobile application using the at least one aspect file;
intercepting a request from the mobile application to the one or more functions, wherein the request includes a source text string;
transmitting the at least one source text string to the translation engine via the at least one communication channel;
receiving at least one translated text string corresponding to the at least one source text string from the translation engine; and
rendering the at least one translated text string on an interface on execution of the one or more functions.

2. The method of claim 1, wherein the request to the one or more functions is intercepted by the translation library before execution of the one or more functions of the mobile application.

3. The method of claim 1, wherein the translated text string is in a language of the computing device.

4. The method of claim 1, wherein receiving at least one translated text string from the translation engine further includes receiving said translated text string from a translation repository, wherein the translation repository comprises translated text strings corresponding to source text strings.

5. The method of claim 1, further comprising storing the source text string from the request in the translation repository for translation in an event when no translated text string corresponding to the source text string is found in the translation repository.

6. A system for localization of a mobile application, the system comprising:
one or more hardware processors configured to communicate with a tangible, non-transitory memory, the one or more hardware processors comprising:
an identification module configured to identify one or more locations of one or more functions related to display of one or more items in the mobile application;
a weaving module configured to:
insert one or more translation libraries for the one or more locations, wherein, the one or more translation libraries include at least one aspect file, wherein the at least one aspect file includes at least one pointcut configured to intercept at the one or more functions and to form at least one communication channel between the one or more locations and a translation engine;
build the mobile application to install the at least one pointcut in the mobile application using the at least one aspect file;
an interception module configured to:
intercept a request from the mobile application to the one or more functions, wherein the request includes at least one source text string; and
transmit the at least one source text string to the translation engine; and
a localization module configured to:
receive the at least one translated text string corresponding to the at least one source text string from the translation engine;
render the at least one translated text string on an interface on execution of the one or more functions.

7. The system of claim 6, wherein the request to the one or more functions is intercepted by the translation library before execution of the one or more functions of the mobile application.

8. The system of claim 6, wherein the translated text string is in a language of the computing device.

9. The system of claim 6, wherein the translation engine receives a translated text string from a translation repository, wherein the translation repository comprises translated text strings corresponding to source text strings in the mobile application.

10. The system of claim 6, wherein the translation repository is configured to store the source text string from the request in an event when no translated text string corresponding to the source text string is found in the translation repository.
